(19) United States
(12) Patent Application Publication
(10) Pub. No.: US 2025/0284165 A1
(43) Pub. Date: Sep. 11, 2025

(54) ELECTRO-OPTICAL DEVICE AND ELECTRONIC APPARATUS

(71) Applicant: SEIKO EPSON CORPORATION, Tokyo (JP)

(72) Inventor: Yuki KOGA, AZUMINO-SHI (JP)

(73) Assignee: SEIKO EPSON CORPORATION, Tokyo (JP)

(21) Appl. No.: 19/071,760

(22) Filed: Mar. 6, 2025

(30) Foreign Application Priority Data
Mar. 7, 2024 (JP) 2024-035132

(51) Int. Cl. G02F 1/1368; G02F 1/1362

(52) U.S. Cl. CPC G02F 1/1368; G02F 1/136209; G02F 1/136286

(57) ABSTRACT

An electro-optical device includes a substrate, a transistor including a gate electrode and a semiconductor layer, a scanning line, a first light shielding portion disposed in a first direction with respect to the semiconductor layer, and a second light shielding portion disposed in a second direction with respect to the semiconductor layer, the first light shielding portion includes a first portion that is extends from a first insulating layer between the scanning line and the gate electrode to a second insulating layer between the semiconductor layer and the second light shielding portion, an intermediate layer is disposed between the first portion and the second light shielding portion to be in contact with the first portion and the second light shielding portion, and the intermediate layer includes a layer having an insulating property and contains a material different from materials of the first insulating layer and the second insulating layer.

The present application is based on, and claims priority from JP Application Serial Number 2024-035132, filed Mar. 7, 2024, the disclosure of which is hereby incorporated by reference herein in its entirety.

### BACKGROUND

### 1. Technical Field

The present disclosure relates to an electro-optical device and an electronic apparatus.

### 2. Related Art

For electronic apparatuses such as projectors, for example, electro-optical devices such as liquid crystal display devices whose optical characteristics can be changed for each pixel are used. As an example of the electro-optical device, a display device disclosed in JP-A-2015-7806 is known.

The display device disclosed in described in JP-A-2015-7806 includes a thin film transistor (TFT) including a semiconductor film and a gate electrode disposed in a layer above the semiconductor film, and a scanning line disposed in a layer above the gate electrode. The gate electrode and the scanning line are electrically coupled via a contact hole. Further, in the display device, the scanning line provided in a layer above the semiconductor film is used as a light shielding layer.

In devices of the related art, a scanning line provided in a layer above a semiconductor film is used as a light shielding layer, but there is a problem that a light shielding property with respect to the semiconductor film is not sufficient only with this.

### SUMMARY

According to an aspect of the present disclosure, an electro-optical device includes a substrate, a transistor including a gate electrode disposed in a first direction with respect to the substrate and a semiconductor layer disposed between the substrate and the gate electrode, a scanning line disposed in the first direction with respect to the gate electrode and electrically coupled to the gate electrode, a first light shielding portion disposed in the first direction with respect to the semiconductor layer and overlapping the semiconductor layer in plan view when viewed in the first direction, and a second light shielding portion disposed in a second direction opposite to the first direction with respect to the semiconductor layer and overlapping the semiconductor layer in plan view, in which a potential of the first light shielding portion and a potential of the second light shielding portion are different from each other, the first light shielding portion includes a first portion that is provided on both sides of the semiconductor layer in a width direction and extends from a first insulating layer between the scanning line and the gate electrode to a second insulating layer between the semiconductor layer and the second light shielding portion, an intermediate layer is disposed between the first portion and the second light shielding portion to be in contact with the first portion and the second light shielding portion, and the intermediate layer includes a layer having an insulating property and contains a material different from materials of the first insulating layer and the second insulating layer.

According to an aspect of the present disclosure, an electronic apparatus includes an electro-optical device, and a control unit configured to control an operation of the electro-optical device.

### BRIEF DESCRIPTION OF THE DRAWINGS

FIG. 1 is a plan view of an electro-optical device according to an embodiment.

FIG. 2 is a cross-sectional view taken along line A-A of the electro-optical device shown in FIG. 1.

FIG. 3 is an equivalent circuit diagram showing an electrical configuration of an element substrate of FIG. 1.

FIG. 4 is a plan view showing a portion of the element substrate in a display region in FIG. 2.

FIG. 5 is a cross-sectional view taken along line A1-A1 in FIG. 4.

FIG. 6 is a cross-sectional view taken along line A2-A2 in FIG. 4.

FIG. 7 is a plan view showing a transistor in FIG. 5.

FIG. 8 is a plan view of a second light shielding portion shown in FIG. 5.

FIG. 9 is a plan view of a first light shielding portion and a second light shielding portion shown in FIG. 5.

FIG. 10 is a plan view of the first light shielding portion and the second light shielding portion shown in FIG. 5.

FIG. 11 is a cross-sectional view taken along line A3-A3 in FIG. 10.

FIG. 12 is a cross-sectional view taken along line A4-A4 in FIG. 10.

FIG. 13 is a plan view of an intermediate layer shown in FIG. 12.

FIG. 14 is a diagram showing a method of manufacturing the intermediate layer shown in FIG. 12.

FIG. 15 is a diagram showing a method of manufacturing the intermediate layer shown in FIG. 12.

FIG. 16 is a cross-sectional view showing a method of manufacturing a first concave portion.

FIG. 17 is a plan view showing a method of manufacturing the first concave portion.

FIG. 18 is a cross-sectional view showing a method of manufacturing a second concave portion.

FIG. 19 is a plan view showing a method of manufacturing the second concave portion.

FIG. 20 is a plan view showing a method of manufacturing a third concave portion.

FIG. 21 is a diagram showing a method of manufacturing a first light shielding portion.

FIG. 22 is a cross-sectional view showing an intermediate layer in a second embodiment.

FIG. 23 is a cross-sectional view showing the intermediate layer in the second embodiment.

FIG. 24 is a plan view showing a second layer of the intermediate layer shown in FIG. 22.

FIG. 25 is a perspective view showing a personal computer which is an example of an electronic apparatus.

FIG. 26 is a plan view showing a smartphone which is an example of an electronic apparatus.

FIG. 27 is a schematic diagram showing a projector which is an example of an electronic apparatus.

### DESCRIPTION OF EMBODIMENTS

Hereinafter, preferred embodiments of the present disclosure will be described with reference to the accompanying drawings. In the drawings, dimensions or scales of respective portions may be appropriately different from actual ones, and there are portions schematically shown to facilitate understanding. Further, the scope of the present disclosure is not limited to these forms unless there is a particular statement that limits the present disclosure in the following description.

### 1. Electro-Optical Device

### 1A. Basic Configuration

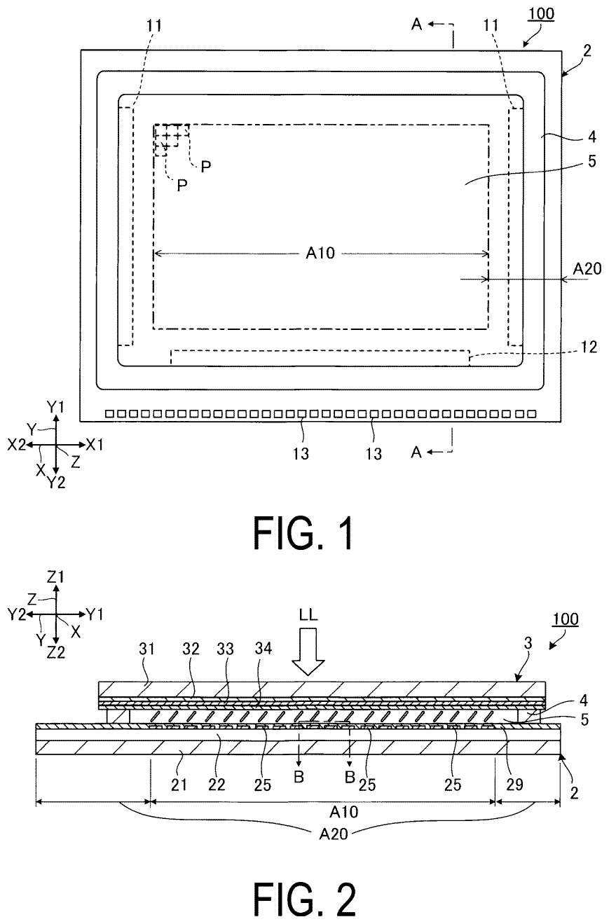

FIG. 1 is a plan view of an electro-optical device 100 according to an embodiment. FIG. 2 is a cross-sectional view taken along line A-A of the electro-optical device 100 shown in FIG. 1. An opposing substrate 3 is not shown in FIG. 1. Further, hereinafter, for convenience of description, an X-axis, a Y-axis, and a Z-axis orthogonal to each other will be used as appropriate. Further, one direction along the X-axis is referred to as an X1 direction, and a direction opposite to the X1 direction is referred to as an X2 direction. Similarly, one direction along the Y-axis is referred to as a Y1 direction, and a direction opposite to the Y1 direction is referred to as a Y2 direction. One direction along the Z-axis is referred to as a Z1 direction, and a direction opposite to the Z1 direction is referred to as a Z2 direction. The Z1 direction is equivalent to a “first direction”, and the Z2 direction is equivalent to a “second direction”.

Further, in this specification, “an element β on an element α” means that the element β is located on the side above the element α. Thus, “an element (on an element α” includes not only a case where the element β is in direct contact with element α, but also a case where the element α and the element β are separated from each other. Further, “electrical coupling” between an element α and an element β includes not only a configuration where the element α and the element β are electrically coupled by being directly bonded to each other, but also a configuration where the element α and the element β are electrically coupled indirectly through another conductive material.

The electro-optical device 100 shown in FIGS. 1 and 2 is a transmissive electro-optical device using an active matrix drive scheme. The electro-optical device 100 includes an element substrate 2, an opposing substrate 3, a frame-shaped sealing member 4, and a liquid crystal layer 5. As shown in FIG. 2, the element substrate 2, the liquid crystal layer 5 and the opposing substrate 3 are arranged in this order in the Z1 direction. Viewing from the Z1 direction or Z2 direction, which is a direction in which these overlap, is referred to as “plan view”. Further, although the shape of the electro-optical device 100 shown in FIG. 1 is a rectangular shape in plan view, the shape may have a polygonal shape or a circular shape other than a rectangular shape.

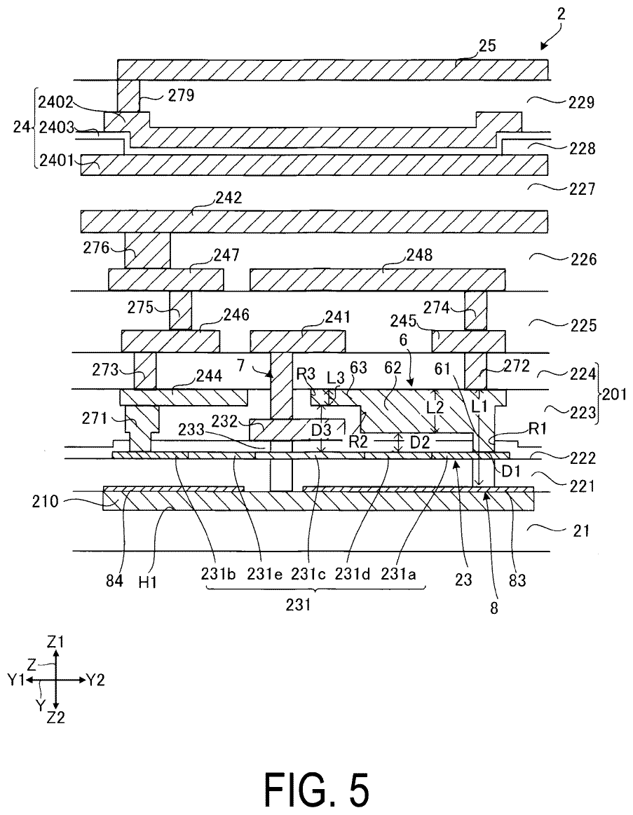

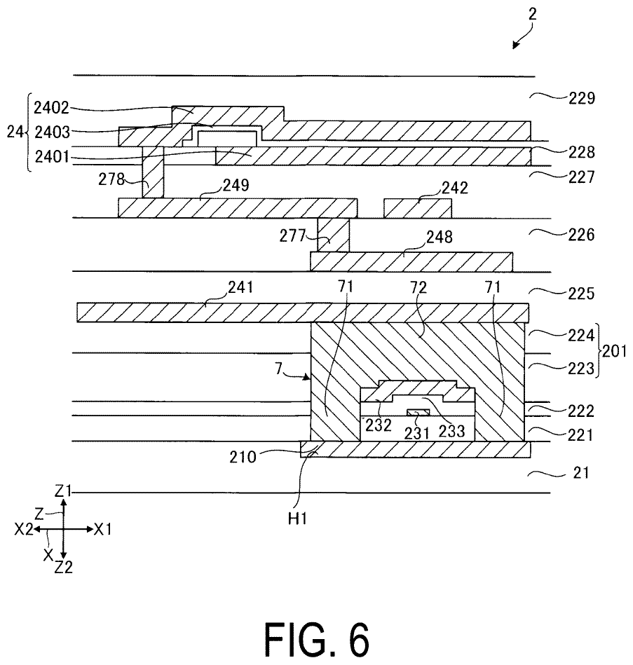

The element substrate 2 shown in FIG. 2 includes a first substrate 21 having light transmittance, a stacked body 22 having light transmittance, a plurality of pixel electrodes 25 having light transmittance, and a first orientation film 29 having light transmittance. The first substrate 21 is equivalent to a “substrate”. The first substrate 21, the stacked body 22, the plurality of pixel electrodes 25, and the first orientation film 29 are stacked in this order in the Z1 direction. In addition, “light transmittance” means transmittance of visible light and preferably indicates that the transmittance to visible light is 50% or more. In addition, as will be described later in detail, the element substrate 2 includes a first light shielding portion 6 having a light shielding property shown in FIGS. 5 and 6, a second light shielding portion 210, and a third light shielding portion 7 having a light shielding property. “Light shielding property” means a light shielding property against visible light, and preferably means that the transmittance of the visible light is less than 50%, and more preferably 10% or less.

The first substrate 21 is a flat plate having light transmittance and an insulating property, and is constituted by a glass substrate or a quartz substrate, for example. The stacked body 22 includes a plurality of insulating films having light transmittance. In addition, the stacked body 22 is provided with various wiring lines and the like. The pixel electrode 25 is used for applying an electric field to the liquid crystal layer 5. The pixel electrode 25 includes a transparent conductive material such as indium tin oxide (ITO), indium zinc oxide (IZO), and fluorine-doped tin oxide (FTO). Although not shown in the drawings, the element substrate 2 includes a plurality of dummy pixel electrodes surrounding the plurality of pixel electrodes 25 in plan view. In addition, the first orientation film 29 has light transmittance and an insulating property. The first orientation film 29 aligns liquid crystal molecules in the liquid crystal layer 5. The first orientation film 29 is disposed to cover the plurality of pixel electrodes 25. The material of the first orientation film 29 is polyimide, silicon oxide, and the like.

The opposing substrate 3 is disposed to face the element substrate 2. The opposing substrate 3 includes a second substrate 31 having light transmittance, an inorganic insulating layer 32 having light transmittance, a common electrode 33 having light transmittance, and a second orientation film 34 having light transmittance. In addition, although not shown in the drawings, the opposing substrate 3 includes a light shielding parting that surrounds the plurality of pixel electrodes 25 in plan view.

The second substrate 31, the inorganic insulating layer 32, the common electrode 33, and the second orientation film 34 are stacked in this order in the Z2 direction. The second substrate 31 is a flat plate having light transmittance and an insulating property, and is constituted by a glass substrate or a quartz substrate, for example. The inorganic insulating layer 32 has light transmittance and an insulation property, and is made of an inorganic material containing silicon, such as silicon oxide. The common electrode 33 is an opposing electrode disposed to face the plurality of pixel electrodes 25 through the liquid crystal layer 5. The common electrode 33 is used for applying an electric field to the liquid crystal layer 5. The common electrode 33 has light transmittance and conductivity. The common electrode 33 contains, for example, a transparent conductive material such as ITO, IZO, and FTO. The second orientation film 34 has light transmittance and an insulating property. The second orientation film 34 aligns liquid crystal molecules in the liquid crystal layer 5. The material of the second orientation film 34 is polyimide, silicon oxide and the like, for example.

The sealing member 4 is disposed between the element substrate 2 and the opposing substrate 3. The sealing member 4 is formed using, for example, an adhesive containing various curable resins such as an epoxy resin. The sealing member 4 may include a gap material made of an inorganic material such as glass.

The liquid crystal layer 5 is disposed in a region surrounded by the element substrate 2, the opposing substrate 3, and the sealing member 4. The liquid crystal layer 5 is an electro-optical layer whose optical characteristics change depending on an electric field. The liquid crystal layer 5 includes liquid crystal molecules having positive or negative dielectric anisotropy. An orientation of the liquid crystal molecules changes depending on a voltage applied to the liquid crystal layer 5.

As shown in FIG. 1, a plurality of scanning line drive circuits 11, a signal line drive circuit 12 and a plurality of external terminals 13 are disposed at the element substrate 2. Some of the plurality of external terminals 13 are coupled to a wiring (not shown) routed from the scanning line drive circuit 11 or the signal line drive circuit 12. Further, the plurality of external terminals 13 include a terminal to which a constant potential Vcom is applied. The terminal is electrically coupled to the common electrode 33 of the opposing substrate 3 through a wiring line and a conductive material (not shown). In this manner, the constant potential Vcom is supplied to the common electrode 33.

The electro-optical device 100 includes a display region A10 in which an image is displayed, and a peripheral region A20 located outside the display region A10 in plan view. A plurality of pixels P disposed in a matrix are provided in the display region A10. The plurality of pixel electrodes 25 are disposed in a one-to-one relationship with the plurality of pixels P. The common electrode 33 described above is provided in common for the plurality of pixels P. Further, the peripheral region A20 surrounds the display region A10 in plan view. The scanning line drive circuit 11 and the signal line drive circuit 12 are disposed in the peripheral region A20.

In the present embodiment, the electro-optical device 100 is of a transmissive type. More specifically, as shown in FIG. 2, after light LL is incident on the opposing substrate 3, the light LL is modulated before being emitted from the element substrate 2, whereby an image is displayed. Light having been incident on the element substrate 2 may be modulated before being emitted from the opposing substrate 3, whereby an image is displayed.

Further, the electro-optical device 100 is applied to, for example, a display device that performs color display, of a personal computer, a smartphone, or the like, which will be described below. When the electro-optical device 100 is applied to the display device, a color filter is appropriately used for the electro-optical device 100. Further, the electro-optical device 100 is applied to, for example, a projection type projector, which will be described later. In this case, the electro-optical device 100 functions as a light valve. In this case, the color filter is omitted from the electro-optical device 100.

### 1B. Electrical Configuration of Element Substrate 2

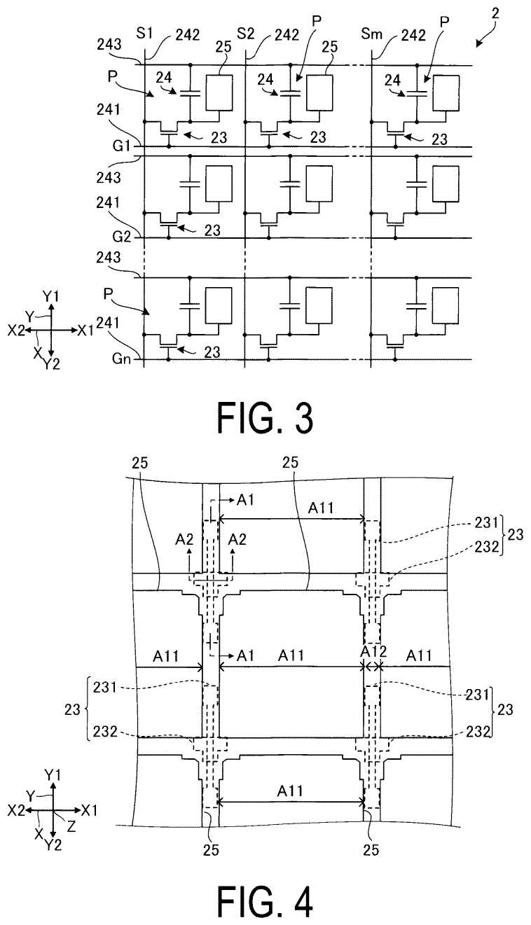

FIG. 3 is an equivalent circuit diagram showing an electrical configuration of the element substrate 2 of FIG. 1. As shown in FIG. 3, the element substrate 2 includes a plurality of transistors 23, n scanning lines 241, m signal lines 242 and n constant potential lines 243. n and m are integers equal to or greater than 2. The transistor 23 is arranged in a manner corresponding to each intersection of the n scanning lines 241 and the m signal lines 242. Each of the transistors 23 is a Thin Film Transistor (TFT) that functions as a switching element, for example. Each of the transistors 23 includes a gate, a source, and a drain.

Each of the n scanning lines 241 extends in the X1 direction, and the n scanning lines 241 are disposed at equal intervals in the Y1 direction. Each of the n scanning lines 241 is electrically coupled to the gates of a plurality of corresponding transistors 23. The n scanning lines 241 are electrically coupled to the scanning line drive circuit 11 shown in FIG. 1. Scanning signals G1, G2, . . . , and Gn are supplied line-sequentially from the scanning line drive circuit 11 to the 1 to n scanning lines 241.

Each of the m signal lines 242 shown in FIG. 3 extends in the Y1 direction, and the m signal lines 242 are arranged at equal intervals in the X1 direction. The m signal lines 242 are respectively electrically coupled to the sources of the plurality of corresponding transistors 23. The m signal lines 242 are electrically coupled to the signal line drive circuit 12 shown in FIG. 1. Image signals S1, S2, . . . , and Sm are supplied in parallel from the signal line drive circuit 12 to the 1 to m signal lines 242.

The n scanning lines 241 and the m signal lines 242 shown in FIG. 3 are electrically insulated from each other and disposed in a grid pattern in plan view. A region surrounded by two adjacent scanning lines 241 and two adjacent signal lines 242 corresponds to the pixel P. The transistor 23, the pixel electrode 25 and a capacitive element 24 are provided for each pixel P. The pixel electrode 25 is provided in a one-to-one relationship for the transistor 23. Each pixel electrode 25 is electrically coupled to the drain of the corresponding transistor 23.

The n constant potential lines 243 are extended in the X1 direction, and the n constant potential lines 243 are arranged at equal intervals in the Y2 direction. Further, the n constant potential lines 243 are electrically insulated from the n scanning lines 241 and the m signal lines 242, and are disposed at intervals from these lines. A constant potential Vcom is applied to each constant potential line 243. Each of the n constant potential lines 243 is electrically coupled to one of the two electrodes of the corresponding capacitive element 24. Each capacitive element 24 is a storage capacitor for holding the potential of the pixel electrode 25. The capacitive element 24 is provided in a one-to-one relationship for the transistor 23. In addition, the other of the two electrodes of each capacitive element 24 is electrically coupled to the corresponding pixel electrode 25. Therefore, the constant potential Vcom is applied to one electrode of the capacitive element 24, and the other electrode is electrically coupled to the drain of the transistor 23.

When the scanning signals G1, G2, . . . , and Gn sequentially become active, and the n scanning lines 241 are sequentially selected, the transistors 23 coupled to the selected scanning line 241 are turned on. Then, the image signals S1, S2 . . . and Sm with values corresponding to the gradation to be displayed through the m signal lines 242 are taken by the pixel P corresponding to the selected scanning line 241, and applied to the pixel electrode 25. Thereby, a voltage corresponding to the gradation to be displayed is applied to a liquid crystal capacitor formed between the pixel electrode 25 and the common electrode 33 in FIG. 2, and the orientation of the liquid crystal molecules changes in accordance with the applied voltage. In addition, the applied voltage is held by the capacitive element 24. Light is modulated due to such changes in the orientation of liquid crystal molecules, making gradation display possible.

### 1C. Structure of Portion of Element Substrate 2

FIG. 4 shows a portion of the element substrate 2 in the display region A10 of FIG. 2. As shown in FIG. 4, the display region A10 includes a plurality of opening regions A11, and a light shielding region A12. The plurality of opening regions A11 are disposed in a matrix in plan view. The shape of the light shielding region A12 in plan view is a frame shape located between the plurality of opening regions A11. Each opening region A11 is a region in which the pixel electrode 25 is disposed, and is a region through which light passes. On the other hand, the transistor 23 is disposed in the light shielding region A12. Although not shown in FIG. 4, various wiring lines such as the scanning lines 241, the signal lines 242, and the constant potential lines 243 shown in FIG. 3, and the capacitive element 24 are disposed in the light shielding region A12.

FIG. 5 is a cross-sectional view taken along line A1-A1 in FIG. 4. FIG. 6 is a cross-sectional view taken along line A2-A2 in FIG. 4. As shown in FIGS. 5 and 6, the element substrate 2 includes the first substrate 21, which is a “substrate”, and the stacked body 22. The stacked body 22 includes a plurality of insulating layers 221, 222, 223, 224, 225, 226, 227, 228 and 229. The insulating layers 221, 222, 223, 224, 225, 226, 227, 228 and 229 are stacked in this order from the first substrate 21. The insulating layers 221 to 229 have light transmittance and an insulating property. The material of each of the insulating layers 221 to 229 is an inorganic material containing silicon, such as silicon oxide and silicon oxynitride. Further, the insulating layer 221 is equivalent to a “second insulating layer”, and the insulating layers 223 and 224 configure a first insulating layer 201.

In the stacked body 22, the transistors 23, the scanning lines 241, the signal lines 242, the first light shielding portion 6, and the third light shielding portion 7 are disposed. Further, in the stacked body 22, relay electrodes 244, 245, 246, 247, 248, and 249 are disposed. In addition, the second light shielding portion 210 is disposed on the first substrate 21.

As described above, the first substrate 21 is constituted by, for example, a glass substrate or a quartz substrate. The first substrate 21 has a concave portion H1. The concave portion H1 is a recess formed in the first substrate 21 and is formed for each transistor 23. The concave portion H1 is formed in the Y1 direction which is a direction in which a semiconductor layer 231 to be described later extends.

The second light shielding portion 210 is disposed within the concave portion H1. The second light shielding portion 210 is formed, for example, using a damascene method. The second light shielding portion 210 is provided to prevent light from being incident on the semiconductor layer 231 of the transistor 23. The first substrate 21 may not have the concave portion H1. In this case, the second light shielding portion 210 is disposed on a flat surface of the first substrate 21 which faces in the Z1 direction. In addition, the second light shielding portion 210 overlaps the semiconductor layer 231 of the transistor 23 to be described below in plan view and is disposed between the first substrate 21 and the semiconductor layer 231. The second light shielding portion 210 functions as a back surface light shielding portion disposed in a layer below the semiconductor layer 231.

An intermediate layer 8 is disposed on the second light shielding portion 210. The intermediate layer 8 is provided for each pixel P and includes a first intermediate portion 83 and a second intermediate portion 84. The intermediate layer 8 is provided to adjust a distance between the second light shielding portion 210 and the first light shielding portion 6 to be described below.

The second transistor 23 is disposed on the insulating layer 221. The transistor 23 includes the semiconductor layer 231, a gate electrode 232, and a gate insulating film 233. The semiconductor layer 231 is disposed on the insulating layer 221 equivalent to a “second insulating layer”. The insulating layer 221 is a layer between the semiconductor layer 231 and the second light shielding portion 210. Furthermore, the gate electrode 232 is disposed on the insulating layer 222. The gate insulating film 233 is interposed between the gate electrode 232 and the semiconductor layer 231. The region of the insulating layer 222 which corresponds to the gate electrode 232 in plan view is equivalent to the gate insulating film 233.

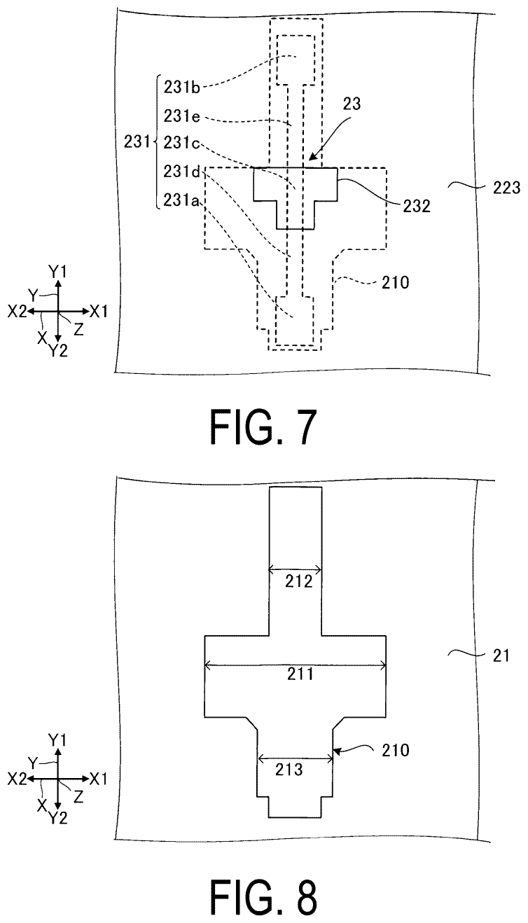

FIG. 7 is a plan view of the transistor 23 in FIG. 5. The transistor 23 shown in FIG. 7 has a lightly doped drain (LDD) structure. The semiconductor layer 231 extends in the Y1 direction. The width direction of the semiconductor layer 231 is along the X-axis. The semiconductor layer 231 is disposed between the first substrate 21 and the gate electrode 232. The semiconductor layer 231 has a drain region 231a, a source region 231b, a channel region 231c, a lightly doped drain region 231d, and a lightly doped source region 231e. The channel region 231c is located between the drain region 231a and the source region 231b. The lightly doped drain region 231d is located between the channel region 231c and the drain region 231a. The lightly doped source region 231e is located between the channel region 231c and the source region 231b. The semiconductor layer 231 is made of polysilicon, for example. A region other than the channel region 231c is doped with impurities that increase conductivity. The impurity concentration in the lightly doped drain region 231d is lower than the impurity concentration in the drain region 231a. The impurity concentration in the lightly doped source region 231e is lower than the impurity concentration in the source region 231b. For example, the transistor 23 does not need to have an LDD structure, and the lightly doped source region 231e and the lightly doped drain region 231d may be omitted.

The gate electrode 232 is made of polysilicon doped with impurities that increase conductivity, for example. Note that the gate electrode 232 may be made of a conductive material of a metal, metal oxide, and metal compound. The gate electrode 232 overlaps with the channel region 231c of the semiconductor layer 231 in plan view. In addition, the gate insulating film 233 is composed of a silicon oxide film deposited by a heat oxidation or chemical vapor deposition (CVD) method or the like.

As shown in FIG. 5, a first light shielding portion 6 is disposed in the insulating layer 222. The first light shielding portion 6 is formed, for example, using a damascene method. The first light shielding portion 6 is disposed in a through hole formed in the insulating layers 221 to 223. The through hole includes a first concave portion R1, a second concave portion R2, and a third concave portion R3. In addition, the first light shielding portion 6 is directly coupled to the drain region 231a of the semiconductor layer 231. Thus, the first light shielding portion 6 is a pixel potential.

As shown in FIG. 5, the first light shielding portion 6 includes a first portion 61, a second portion 62, and a third portion 63. The first portion 61 is disposed in the first concave portion R1 described above. The second portion 62 is disposed in the second concave portion R2. The third portion 63 is disposed in the third concave portion R3. The first light shielding portion 6 functions as an upper light shielding portion disposed in a layer above the semiconductor layer 231.

As described above, in the element substrate 2, the second light shielding portion 210 is provided in the lower layer of the semiconductor layer 231, and the first light shielding portion 6 is disposed in the upper layer of the semiconductor layer 231. For this reason, a light shielding property can be improved compared to the related art.

As shown in FIG. 5, the relay electrode 244 is disposed in the insulating layer 223. The relay electrode 244 is electrically coupled to the source region 231b of the semiconductor layer 231 via a contact 271. For example, the contact 271 is a contact plug that fills a hole that penetrates the insulating layers 222 and 223. The relay electrode 244 and the contact 271 may be integrally formed of the same material, or may be formed of different materials.

As shown in FIG. 5, the scanning line 241, the relay electrode 245 and the relay electrode 246 are disposed on the insulating layer 224. The scanning line 241 is electrically coupled to the gate electrode 232 via the third light shielding portion 7. The relay electrode 245 is electrically coupled to the first light shielding portion 6 via a contact 272 that penetrates the insulating layer 224. The relay electrode 246 is electrically coupled to the relay electrode 244 via a contact 273 that penetrates the insulating layer 224. In addition, the first insulating layer 201 configured with the insulating layers 224 and 223 is located between the scanning line 241 and the gate electrode 232.

As shown in FIG. 6, the third light shielding portion 7 is disposed in the insulating layers 221 to 224. The third light shielding portion 7 is formed using, for example, a damascene method. The third light shielding portion 7 is directly coupled to the scanning line 241 and the gate electrode 232. Thus, the third light shielding portion 7 is at a gate potential.

The third light shielding portion 7 includes two fourth portions 71 and a fifth portion 72. The two fourth portions 71 are spaced apart from each other, extend from the scanning line 241 to the second light shielding portion 210, and are coupled thereto. Thus, the second light shielding portion 210 has the same potential as that of the gate electrode 232 and functions as a back gate. Each of the two fourth portions 71 is positioned on the outer side of the first portion 61 in a direction along the X-axis. The fifth portion 72 is disposed between the two fourth portions 71 and is coupled to the scanning line 241.

The relay electrode 247 and the relay electrode 248 are disposed on the insulating layer 225. The relay electrode 247 is electrically coupled to the relay electrode 246 via a contact 275 that penetrates the insulating layer 225. The relay electrode 248 is electrically coupled to the relay electrode 245 via a contact 274 that penetrates the insulating layer 225.

The signal line 242 is disposed on insulating layer 226. The signal line 242 is electrically coupled to the relay electrode 247 via a contact 276 that penetrates the insulating layer 226. Thus, the signal line 242 is electrically coupled to the source region 231b via the contact 276, the relay electrode 247, the contact 275, the relay electrode 246, the contact 273, the relay electrode 244 and the contact 271.

As shown in FIG. 6, the relay electrode 249 is disposed on the insulating layer 226. The relay electrode 249 is electrically coupled to the relay electrode 248 via a contact 277 that penetrates the insulating layer.

A capacitive element 24 is disposed on the insulating layer 227. The capacitive element 24 includes a pair of electrodes 2401 and 2402 and a dielectric layer 2403. The electrode 2401 is disposed on the insulating layer 227. The electrode 2402 is disposed on the insulating layer 228. The dielectric layer 2403 is disposed between the electrodes 2401 and 2402. The dielectric layer 2403 contains, for example, HfO₂, Al₂O₃, or the like. The electrode 2401 also serves as the constant potential line 243 in FIG. 2. In addition, as shown in FIG. 6, the electrode 2402 is electrically coupled to the relay electrode 249 via a contact 278 that penetrates the insulating layers 227 and 228. Thus, as shown in FIGS. 5 or 6, the electrode 2402 is electrically coupled to the drain region 231a via the contact 278, the relay electrode 249, the contact 277, the relay electrode 248, the contact 274, the relay electrode 245, the contact 272 and the first light shielding portion 6.

As shown in FIG. 5, the pixel electrode 25 is disposed on the insulating layer 229. The pixel electrode 25 is electrically coupled to the electrode 2402 via a contact 279 that penetrates the insulating layer 229.

Each of the above-mentioned scanning line 241, signal line 242, electrode 2401, electrode 2402, relay electrodes 244, 245, 246, 247, 248, and 249 contains, for example, a metal such as tungsten (W), titanium (Ti), chromium (Cr), iron, and aluminum (Al), a metal nitride, a metal silicide, or the like. These may be single layers or multilayers. For example, these are constituted by a stacked body of an aluminum film and a titanium nitride film.

In addition, each of the above-mentioned contacts 271 to 279 contains, for example, a metal such as tungsten (W), titanium (Ti), chromium (Cr), iron (Fe), and aluminum (Al), a metal nitride, and a metal silicide. Each of the contacts 271 to 279 may be a single layer or a stacked layer. Each of the contacts 271 to 279 may be formed integrally with the electrode or wiring line to which it is coupled, or may be formed separately.

The configuration of the element substrate 2 shown in FIGS. 5 and 6 is merely one example. For example, the element substrate 2 may include capacitive elements other than the capacitive element 24. In addition, the scanning line 241, the signal line 242, and the capacitive element 24 are arranged in this order in the Z1 direction, but they do not have to be arranged side by side.

### 1D. First Light Shielding Portion 6, Third Light Shielding Portion 7, and Second Light Shielding Portion 210

FIG. 8 is a plan view of the second light shielding portion 210 shown in FIG. 5. The second light shielding portion 210 shown in FIG. 8 has an elongated shape of which the longitudinal direction is a direction along the Y-axis which is a direction in which the scanning line 241 extends in plan view.

The second light shielding portion 210 includes a wide portion 211, a first narrow portion 212, and a second narrow portion 213. The wide portion 211 is positioned between the first narrow portion 212 and the second narrow portion 213, and is wider than the first narrow portion 212 and the second narrow portion 213 in a width that is a length along the X-axis. The first narrow portion 212 extends from the wide portion 211 in the Y1 direction. The second narrow portion 213 extends from the wide portion 211 in the Y2 direction.

Referring to FIGS. 7 and 8, the wide portion 211 overlaps the gate electrode 232 in plan view. The first narrow portion 212 overlaps the source region 231b in plan view. The second narrow portion 213 overlaps the drain region 231a in plan view.

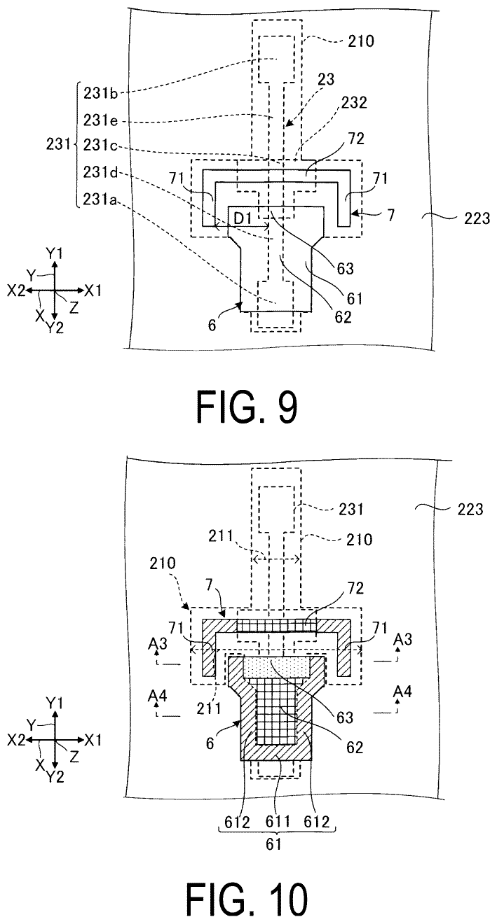

FIGS. 9 and 10 are plan views of the first light shielding portion 6 and the third light shielding portion 7, respectively. In FIG. 10, in order to facilitate understanding, the first portion 61 is hatched, the second portion 62 is meshed, and the third portion 63 is dotted. The fourth portion 71 is hatched, and the fifth portion 72 is dotted.

As shown in FIG. 9, the first light shielding portion 6 and the third light shielding portion 7 overlap the second light shielding portion 210 in plan view. The first light shielding portion 6 and the third light shielding portion 7 are disposed to be separated from each other. The third light shielding portion 7 is positioned outside the first light shielding portion 6 in plan view. The first light shielding portion 6 overlaps the drain region 231a and the lightly doped drain region 231d of the semiconductor layer 231 in plan view. Furthermore, the third light shielding portion 7 overlaps the gate electrode 232 and the channel region 231c of the semiconductor layer 231 in plan view.

As described above, the first light shielding portion 6 includes the first portion 61, the second portion 62, and the third portion 63. Specifically, the first portion 61 includes a drain coupling portion 611 and two side surface light shielding portions 612. The drain coupling portion 611 is a portion that overlaps the drain region 231a in plan view and is directly coupled to the drain region 231a. The drain coupling portion 611 is positioned in the Y2 direction with respect to the second portion 62 and extends along the X-axis. The side surface light shielding portions 612 do not overlap the semiconductor layer 231 in plan view. The side surface light shielding portions 612 are positioned in the X1 direction or the X2 direction with respect to the second portion 62 and the third portion 63 in plan view, and extend substantially along the Y-axis.

The second portion 62 is positioned in the Y2 direction with respect to the third portion 63 in plan view. The second portion 62 overlaps the lightly doped drain region 231d in plan view. The lightly doped drain region 231d is a region of the semiconductor layer 231 in which light leakage is most likely to occur. Thus, the second portion 62 overlaps the lightly doped drain region 231d in plan view, and thus it is possible to effectively curb the incidence of light on the lightly doped drain region 231d by the first light shielding portion 6. Thus, it is possible to effectively curb light leakage.

As described above, in the present embodiment, the transistor 23 has an LDD structure. However, the lightly doped source region 231e and the lightly doped drain region 231d may be omitted. In this case, it is preferable that the second portion 62 overlap a bonding portion between the drain region 231a and the source region 231b in plan view. The bonding portion is a region where light leakage is likely to occur. Thus, the second portion 62 overlaps the bonding portion in plan view, and thus it is possible to effectively curb the incidence of light on the bonding portion by the first light shielding portion 6. Thus, it is possible to effectively curb light leakage.

In addition, the third portion 63 overlaps the gate electrode 232 in plan view. For this reason, compared to a case where the third portion 63 does not overlap the gate electrode 232 in plan view, it is possible to curb the incidence of light on the semiconductor layer 231, particularly the lightly doped drain region 231d.

As shown in FIG. 9, each of the fourth portions 71 includes a portion extending along the Y-axis and a portion extending along the X-axis in plan view. The fifth portion 72 extends along the X-axis and is positioned between the two fourth portions 71 in plan view. As shown in FIGS. 9 and 10, the fifth portion 72 overlaps the gate electrode 232 in plan view. Each of the two fourth portions 71 is positioned outside the first portion 61 in a direction along the X-axis in plan view, and does not overlap the gate electrode 232 in plan view.

The third light shielding portion 7 and the first portion 61 surround the lightly doped drain region 231d in plan view. For this reason, it is possible to effectively curb the incidence of light from a direction along the XY plane on the lightly doped drain region 231d.

Furthermore, the third light shielding portion 7 is positioned further outward from the first light shielding portion 6 in the X-axis direction. For this reason, as compared to a case where the third light shielding portion 7 is positioned on the inner side of the first light shielding portion 6 in the X-axis direction, it is possible to curb the influence of the third light shielding portion 7, which is a gate potential, on the lightly doped drain region 231d. Thus, it is possible to curb an increase in an off-leak current. For this reason, the reduction in display quality due to the occurrence of black spots and the like can be curbed. Note that the off-leak current is a leakage current that flows when the transistor 23 is turned off.

Furthermore, as shown in FIG. 5, the first portion 61 of the first light shielding portion 6 is directly coupled to the drain region 231a. For this reason, the potential of the first light shielding portion 6 and the potential of the drain region 231a of the semiconductor layer 231 are the same potential. Thus, even when the first light shielding portion 6 is brought close to the semiconductor layer 231, problems are not likely to occur. Thus, it is easy to bring the first light shielding portion 6 close to the semiconductor layer 231. For this reason, although each of the second portion 62 and the third portion 63 is separated from the semiconductor layer 231, it is easy to bring them close to the semiconductor layer 231. Since the first light shielding portion 6 can be brought close to the semiconductor layer 231, a light shielding property of the first light shielding portion 6 can be improved compared to the related art.

As described above, the potential of the first light shielding portion 6 and the potential of the second light shielding portion 210 are different from each other. Since these potentials are different from each other, it is possible to respectively set the potential of the first light shielding portion 6 and the potential of the second light shielding portion 210. For this reason, it is possible to reduce the electrical adverse effect of each of the first light shielding portion 6 and the second light shielding portion 210 on the semiconductor layer 231.

Specifically, the first light shielding portion 6 is directly coupled to the drain region 231a and is electrically coupled to the drain region 231a. In addition, the second light shielding portion 210 is electrically coupled to the gate electrode 232 and overlaps the semiconductor layer 231 in plan view. Since the first light shielding portion 6 is electrically coupled to the drain region 231a, even when the first light shielding portion 6 is brought close to the drain region 231a, an electrical failure is unlikely to occur. Thus, the first light shielding portion 6 can be brought close to the lightly doped drain region 231d. Accordingly, the first light shielding portion 6 can be brought close to the semiconductor layer 231, and thus a light shielding property of the first light shielding portion 6 can be improved compared to the related art. On the other hand, the second light shielding portion 210 is electrically coupled to the gate electrode 232, and thus the second light shielding portion 210 can be used as a back gate.

The first light shielding portion 6 is at a pixel potential and not at a gate potential. Thus, even when the first light shielding portion 6 is disposed near the semiconductor layer 231, it is possible to curb the influence of the gate potential on the semiconductor layer 231. More specifically, the increase in off-leak current due to the gate potential coming closer to the region other than the channel region 231c of the semiconductor layer 231 can be curbed. In this manner, the reduction in display quality due to the occurrence of black spots and the like can be curbed.

Examples of materials for the first light shielding portion 6, the second light shielding portion 210, and the third light shielding portion 7 include metals such as tungsten (W), titanium (Ti), chromium (Cr), iron (Fe), and aluminum (Al), metal nitrides, and metal silicides. Among these, it is preferable that the first light shielding portion 6 and the third light shielding portion 7 contain tungsten. Among various metals, tungsten is excellent in heat resistance, and its optical density (OD) value is unlikely decrease through heat treatment during manufacturing, for example. Thus, the first light shielding portion 6, the second light shielding portion 210, and the third light shielding portion 7 contain tungsten, and thus it is possible to particularly effectively prevent light from being incident on the semiconductor layer 231 by the first light shielding portion 6, the second light shielding portion 210, and the third light shielding portion 7. Furthermore, the materials of the first light shielding portion 6, the second light shielding portion 210, and the third light shielding portion 7 may be the same as or different from each other.

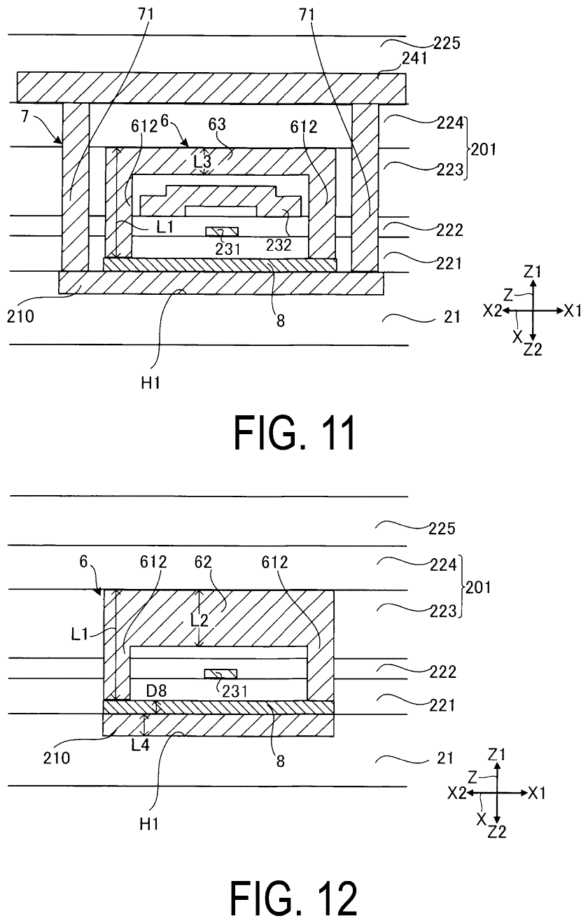

FIG. 11 is a cross-sectional view taken along line A3-A3 in FIG. 9. FIG. 12 is a cross-sectional view taken along line A4-A4 in FIG. 9.

As shown in FIGS. 11 and 12, the two side surface light shielding portions 612 of the first portion 61 are disposed on the outer side of the semiconductor layer 231 in the X-axis direction. That is, the two side surface light shielding portions 612 are disposed on both sides of the semiconductor layer 231 in the width direction. For this reason, it is possible to curb the incidence of light on the semiconductor layer 231 in the X1 direction and the X2 direction by the two side surface light shielding portions 612.

Further, as shown in FIG. 5, FIG. 11, or FIG. 12, the side surface light shielding portion 612 of the first portion 61 extends from the first insulating layer 201, which is a layer between the scanning line 241 and the gate electrode 232, to the insulating layer 221, which is a “second insulating layer”. As shown in FIG. 5, the drain coupling portion 611 of the first portion 61 extends from the first insulating layer 201 to the drain region 231a. In addition, as shown in FIG. 12, the second portion 62 is provided between the semiconductor layer 231 and the insulating layer 225, which is a layer in which the scanning line 241 is provided. As shown in FIG. 11, the third portion 63 is provided between the gate electrode 232 and the insulating layer 225.

A length L3 of the third portion 63 in the Z2 direction, a length L2 of the second portion 62 in the Z2 direction, and a length L1 of the first portion 61 in the Z2 direction are in ascending order. The length L1 is the longest. Thus, the lengths L1, L2, and L3 satisfy a relationship of L3<L2<L1. Each of the lengths L1, L2, and L3 is a maximum length. Thus, the length L1 is the length of the side surface light shielding portion 612.

According to the configuration of the first light shielding portion 6 in which the lengths L1, L2, and L3 satisfy a relationship of L3<L2<L1, the first light shielding portion 6 can be disposed near the semiconductor layer 231. For this reason, it is possible to more effectively curb the incidence of light on the semiconductor layer 231 than the related art. Thus, it is possible to prevent the operation of the transistor 23 from becoming unstable. As a result, it is possible to curb a concern that display defects such as uneven brightness occur. Thus, it is possible to curb deterioration in display quality.

In addition, other wiring lines and electrodes are not interposed between the first light shielding portion 6 and the semiconductor layer 231. For this reason, it is possible to bring the first light shielding portion 6 close to the semiconductor layer 231. Thus, as compared with a case where wiring lines and electrodes are interposed between the first light shielding portion 6 and the semiconductor layer 231, it is possible to curb the incidence of light on the semiconductor layer 231 in the Z1 direction by the first light shielding portion 6.

In addition, as shown in FIG. 5, the upper surfaces of the first portion 61, the second portion 62, and the third portion 63 are flush with each other. Thus, a distance D1 between the first portion 61 and the semiconductor layer 231, a distance D2 between the second portion 62 and the semiconductor layer 231, and a distance D3 between the third portion 63 and the semiconductor layer 231 are in ascending order. The length D3 is the longest. Thus, the lengths D1, D2, and D3 satisfy a relationship of D1<D2<D3. The length D3 is 0 (zero). For this reason, the second portion 62 is closer to the semiconductor layer 231 than the third portion 63 in a direction along the Z-axis. The first light shielding portion 6 includes the second portion 62, it is possible to bring the first light shielding portion 6 close to the semiconductor layer 231. Thus, the incidence of light on the semiconductor layer 231 can be more effectively exhibited.

In particular, the surface of the second portion 62 which faces the semiconductor layer 231 is preferably provided at a position between the surface of the gate electrode 232 which faces the semiconductor layer 231 and the surface of the gate electrode 232 which faces the scanning line 241 in a direction along the Z-axis. The surface of the second portion 62 which faces the semiconductor layer 231 is provided at such a position, and thus a distance between the second portion 62 and the semiconductor layer 231 can be significantly reduced. Furthermore, the second portion 62 overlaps the lightly doped drain region 231d in plan view, and thus the second portion 62 can be brought significantly close to the lightly doped drain region 231d. That is, a distance between the second portion 62 and the lightly doped drain region 231d can be made significantly smaller than that in the related art. For this reason, it is possible to prevent light from being incident on the semiconductor layer 231, particularly on the lightly doped drain region 231d in the Z1 direction. Curbing the incidence of light in the Z1 direction is particularly effective in a mode in which light is incident from the opposing substrate 3 as in the present embodiment.

Examples of materials for the first light shielding portion 6, the second light shielding portion 210, and the third light shielding portion 7 include metals such as tungsten (W), titanium (Ti), chromium (Cr), iron (Fe), and aluminum (Al), metal nitrides, and metal silicides. Among these, it is preferable that the first light shielding portion 6 and the third light shielding portion 7 contain tungsten. Among various metals, tungsten is excellent in heat resistance, and its optical density (OD) value is unlikely decrease through heat treatment during manufacturing, for example. Thus, the first light shielding portion 6, the second light shielding portion 210, and the third light shielding portion 7 contain tungsten, and thus it is possible to particularly effectively prevent light from being incident on the semiconductor layer 231 by the first light shielding portion 6, the second light shielding portion 210, and the third light shielding portion 7. Furthermore, the materials of the first light shielding portion 6, the second light shielding portion 210, and the third light shielding portion 7 may be the same as or different from each other.

For example, the third concave portion R3 may be omitted. In this case, the third portion 63 may be omitted.

### 1E. Intermediate Layer 8

As shown in FIGS. 11 and 12, the intermediate layer 8 is disposed between the first portion 61 of the first light shielding portion 6 and the second light shielding portion 210 so as to be in contact therewith. The intermediate layer 8 has an insulating property. The intermediate layer 8 contains a material different from the materials of the first insulating layer 201 and the insulating layer 221 serving as a “second insulating layer”. That is, the intermediate layer 8 is different from the materials of the insulating layers 221 to 223. By providing such an intermediate layer 8, it is possible to avoid electrical coupling between the first light shielding portion 6 and the second light shielding portion 210. Furthermore, by using the intermediate layer 8 as an etching stopper at the time of manufacturing the element substrate 2, it is possible to reduce the occurrence of a variation in a distance between the first portion 61 of the first light shielding portion 6 and the second light shielding portion 210 for each pixel P. In addition, it is possible to reduce variations in light shielding properties for each electro-optical device 100. The plane area of the intermediate layer 8 is larger than the plane areas of the first portion 61 and the second light shielding portion 210.

Since such an intermediate layer 8 is provided, it is possible to curb occurrence of a variation in light resistance of the semiconductor layer 231 due to a processing variation in the side surface light shielding portion 612 in the plurality of electro-optical devices 100. Specifically, when the end portion of the side surface light shielding portion 612 in the Z2 direction is positioned in a layer above the second light shielding portion 210, a distance between the side surface light shielding portion 612 and the second light shielding portion 210 is likely to vary for each pixel P due to manufacturing errors or the like. In the present embodiment, the intermediate layer 8 is provided between each side surface light shielding portion 612 and the second light shielding portion 210. For this reason, by using the intermediate layer 8 as an etching stopper, it is possible to reduce the occurrence of a variation in a distance between the first portion 61 of the first light shielding portion 6 and the second light shielding portion 210 for each pixel P. Thus, it is possible to effectively curb a decrease in yield. Since it is possible to maintain a constant light shielding shape as compared with the related art, it is possible to stabilize the quality of the electro-optical device 100.

It is preferable that an etching rate of the intermediate layer 8 with respect to a fluorine-based etchant be lower than those of the insulating layer 221 and the first insulating layer 201. Thereby, the intermediate layer 8 can be suitably used as an etching stopper.

The insulating layer 221 and the first insulating layer 201 contain silicon oxide (SiOx) or silicon oxynitride (SiON). The intermediate layer 8 contains silicon nitride (SiN). In this case, the etching rate of the intermediate layer 8 with respect to a fluorine-based etchant is lower than those of the insulating layer 221 and the first insulating layer 201. For this reason, the intermediate layer 8 can be suitably used as an etching stopper.

In addition, a thickness D8 of the intermediate layer 8 is smaller than a thickness L1 of the first portion 61 of the first light shielding portion 6. Further, the thickness D8 of the intermediate layer 8 is smaller than a thickness L4 of the second light shielding portion 210. Since the thickness D8 is smaller than the thickness L4, a distance between the first light shielding portion 6 and the second light shielding portion 210 can be reduced as compared with when the thickness D8 is larger than the thickness L4. For this reason, it is possible to curb penetration of light into the semiconductor layer 231 from between the first light shielding portion 6 and the second light shielding portion 210. Thus, it is possible to reduce the occurrence of a variation in each pixel P due to the provision of the intermediate layer 8 and to particularly effectively exhibit the effect of curbing the penetration of light into the semiconductor layer 231.

The thickness D8 of the intermediate layer 8 is not particularly limited and is, for example, 1000 Å or more and 2000 Å or less. When the thickness is within the above range, it is possible to curb deterioration in a light shielding property due to an increase in the distance between the first light shielding portion 6 and the second light shielding portion 210 while allowing the intermediate layer 8 to suitably function as an etching stopper, as compared with a case where the thickness falls outside the range.

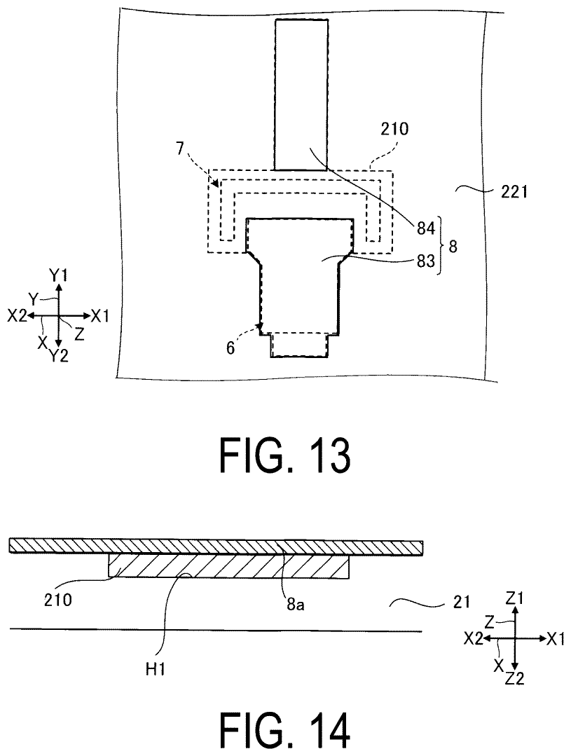

FIG. 13 is a plan view of the intermediate layer 8 shown in FIG. 12. As shown in FIG. 13, the intermediate layer 8 includes a first intermediate portion 83 and a second intermediate portion 84. The second intermediate portion 84 is disposed in the Y1 direction with respect to the first intermediate portion 83 in plan view. The intermediate layer 8 does not overlap the third light shielding portion 7 in plan view and is not coupled to the third light shielding portion 7. Specifically, the third light shielding portion 7 is disposed between the first intermediate portion 83 and the second intermediate portion 84 in plan view. In addition, the first intermediate portion 83 overlaps the first light shielding portion 6 in plan view.

The intermediate layer 8 is also provided in the light shielding region A12 described above, but is not provided in the opening region A11. Thus, even when the intermediate layer 8 is formed of a material that is not excellent in light transmittance, such as silicon nitride, the presence of the intermediate layer 8 makes it possible to avoid a decrease in light transmittance in the opening region A11. When the intermediate layer 8 is light transmissive, a portion of the intermediate layer 8 may be provided in the opening region A11. In addition, the intermediate layer 8 may be disposed at least between the first portion 61 and the second light shielding portion 210. Thus, the second intermediate portion 84 may be omitted.

### 1F. Method of Manufacturing Intermediate Layer 8 and First Light Shielding Portion 6

The intermediate layer 8 and the first light shielding portion 6 described above are manufactured, for example, by the following method. The manufacturing method for these is not limited to the following method.

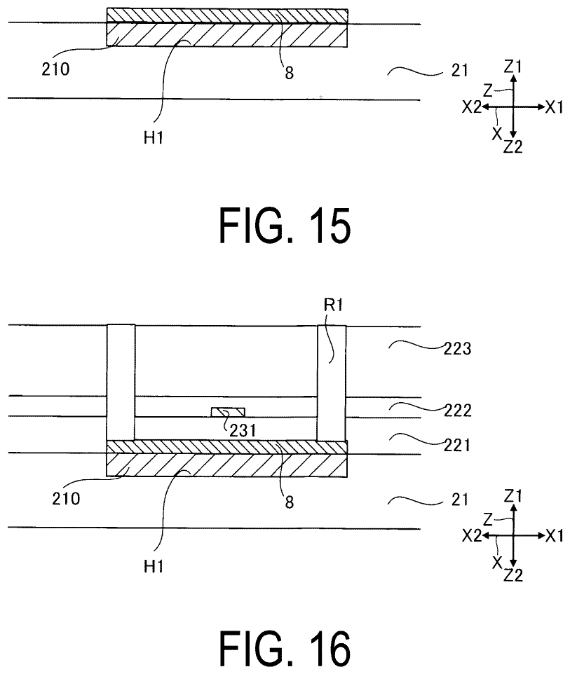

FIGS. 14 and 15 are diagrams showing a method of manufacturing the intermediate layer 8 shown in FIG. 12. As shown in FIG. 14, an insulating film 8a is formed at the first substrate 21 to cover the second light shielding portion 210. The insulating film 8a is made of a material having an insulating property such as silicon nitride. The insulating film 8a is formed by, for example, a vapor deposition method such as chemical vapor deposition (CVD) or a sputtering method. Next, the intermediate layer 8 shown in FIG. 15 is formed by removing a portion of the insulating film 8a by etching.

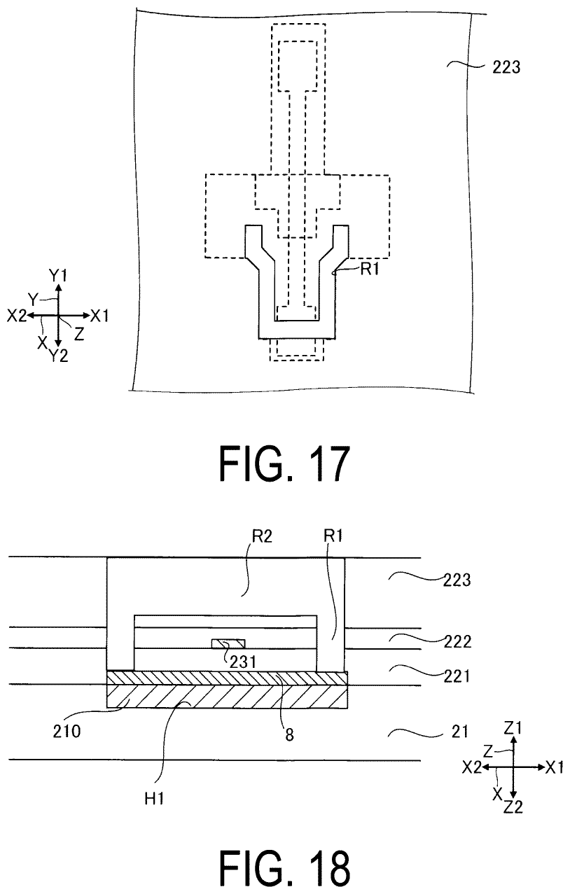

FIG. 16 is a cross-sectional view showing a method of manufacturing the first concave portion R1. FIG. 17 is a plan view showing a method of manufacturing the first concave portion R1. As shown in FIGS. 16 and 17, after the insulating layer 223 is formed, the first concave portion R1 penetrating the insulating layers 221 to 223 is formed by etching. For example, when the insulating layers 221 to 223 are made of an inorganic material containing silicon, portions of the insulating layers 221 to 223 are removed by etching using a fluorine-based etchant. At this time, when the etching rate of the intermediate layer 8 with respect to the etchant is slower than those of the insulating layers 221 to 223, the intermediate layer 8 functions as an etching stopper. Thus, it is possible to reduce the occurrence of a variation in the depth of the first recess portion R1 for each pixel P.

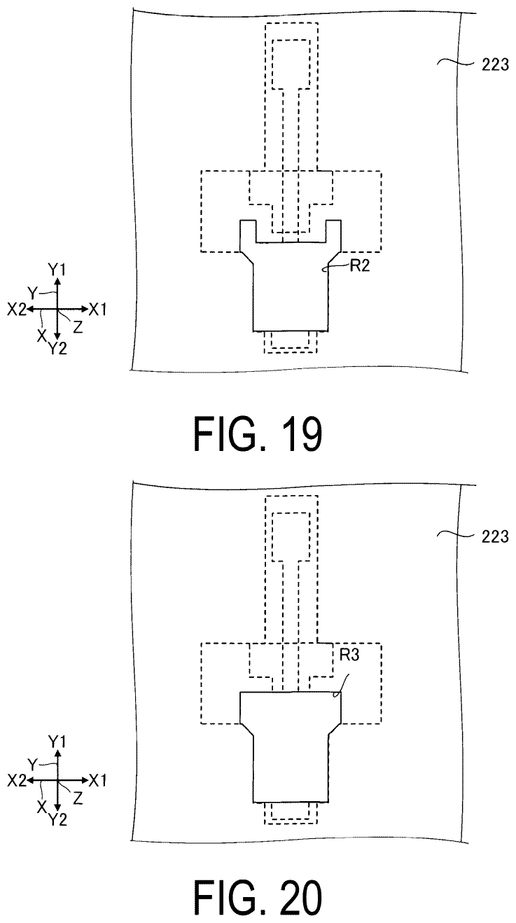

FIG. 18 is a cross-sectional view showing a method of manufacturing the second concave portion R2. FIG. 19 is a plan view showing a method of manufacturing the second concave portion R2. Next, as shown in FIGS. 18 and 19, the second concave portion R2 is formed in the insulating layer 223 by etching. As described above, for example, when the insulating layer 223 is made of an inorganic material containing silicon, a portion of the insulating layer 223 is removed by etching using a fluorine-based etchant.

FIG. 20 is a cross-sectional view showing a method of manufacturing the third concave portion R3. Next, as shown in FIG. 20, the third concave portion R3 is formed in the insulating layer 223 by etching. As described above, for example, when the insulating layer 223 is made of an inorganic material containing silicon, a portion of the insulating layer 223 is removed by etching using a fluorine-based etchant.

The order of manufacturing the first concave portion R1, the second concave portion R2, and the third concave portion R3 is not limited to the above-described order. For example, portions of the first concave portion R1, the second concave portion R2, and the third concave portion R3 may be formed at the same time.

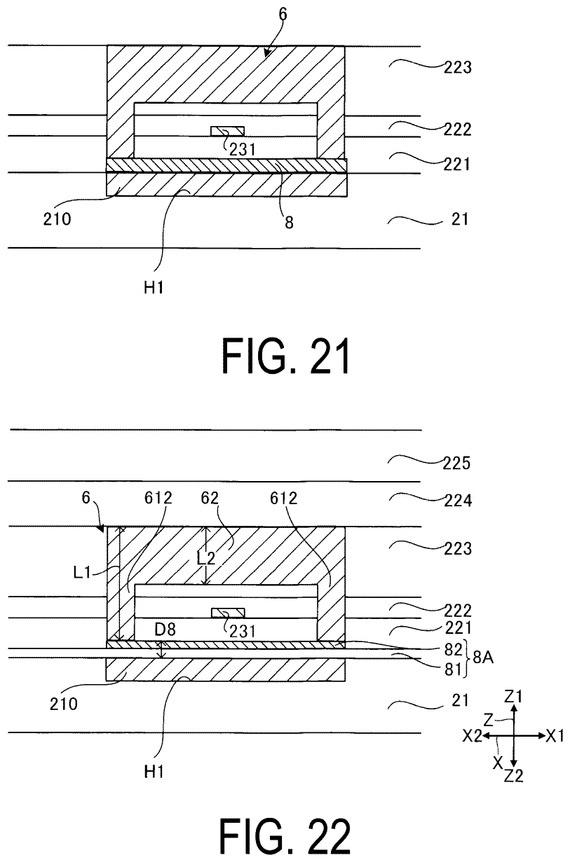

FIG. 21 is a diagram showing a method of manufacturing the first light shielding portion 6. As shown in FIG. 21, the first light shielding portion 6 is formed by filling the first concave portion R1, the second concave portion R2, and the third concave portion R3 with a conductive material such as tungsten.

### 2. Second Embodiment

In a second embodiment described below, for elements having the same operations or functions as those in the first embodiment, the reference numerals used in the description of the first embodiment will be used, and detailed descriptions thereof will be omitted as appropriate.

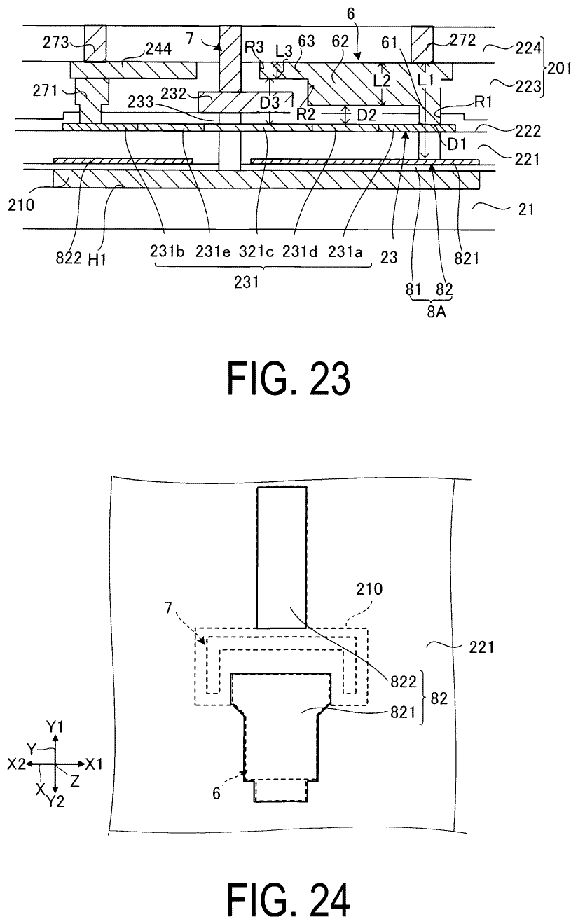

FIGS. 22 and 23 are cross-sectional views showing an intermediate layer 8A in the second embodiment. FIG. 24 is a plan view showing a second layer 82 of the intermediate layer 8A shown in FIG. 22.

As shown in FIGS. 22 and 23, the intermediate layer 8A of the present embodiment includes a first layer 81 and the second layer 82. The first layer 81 and the second layer 82 are stacked in order from a second light shielding portion 210. The second layer 82 is in contact with the second light shielding portion 210. The first layer 81 is a layer having an insulating property. Furthermore, in the present embodiment, the first layer 81 has light transmittance. The first layer 81 is uniformly provided in both a light shielding region A12 and an opening region A11. The second layer 82 contains a material different from those of insulating layers 221 to 223. In the present embodiment, the second layer 82 contains a metal. The etching rate of the second layer 82 with respect to a fluorine-based etchant is lower than the etching rates of the insulating layers 221 to 223. The second layer 82 is in contact with a side surface light shielding portion 612 of a first light shielding portion 6. In addition, the second layer 82 is provided in the light shielding region A12. For this reason, the presence of the second layer 82 makes it possible to avoid a decrease in light transmittance in the opening region A11.

By providing the intermediate layer 8A including the first layer 81 having an insulating property, it is possible to avoid electrical coupling between the first light shielding portion 6 and the second light shielding portion 210. Further, since the intermediate layer 8A includes the second layer 82 containing a material different from those of the insulating layers 221 to 223, it is possible to reduce the occurrence of a variation in a distance between the first portion 61 of the first light shielding portion 6 and the second light shielding portion 210 for each pixel P by using the intermediate layer 8A as an etching stopper at the time of manufacturing an element substrate 2. Thus, it is possible to reduce a variation in light shielding performance in an electro-optical device 100.

The order of stacking the first layer 81 and the second layer 82 may be opposite to that in the example of FIG. 22. That is, the second layer 82 and the first layer 81 may be stacked in order from the second light shielding portion 210. For example, the first layer 81 is made of an

insulating material containing silicon such as silicon oxide or silicon oxynitride. For example, the first layer 81 is made of the same material as those of the insulating layers 221 to 223. Since the first layer 81 is made of the same material as those of the insulating layers 221 to 223, the first layer 81 can be easily formed as compared with a case where the first layer 81 is made of a different material, and even when the first layer 81 is provided in the opening region A11, it is possible to curb a decrease in light transmittance in the opening region A11.

On the other hand, for example, the second layer 82 is formed of a metal such as tungsten, titanium, chromium, iron, or aluminum, a metal nitride, or a metal silicide. For example, the second layer 82 is formed of the same material as that of the first light shielding portion 6. Further, the second layer 82 may be formed of silicon nitride (SiN).

A thickness D8 of the intermediate layer 8A is the same as that in the first embodiment described above. A thickness of the second layer 82 of the intermediate layer 8A is not particularly limited and is 1000 Å or more and 2000 Å or less. The thickness of the second layer 82 is within the above range, and thus it is possible to more easily perform film formation than when the thickness of the second layer 82 falls outside the range, and to curb a decrease in a light shielding property due to an increase in a distance between the first light shielding portion 6 and the second light shielding portion 210.

The thickness of the first layer 81 is not particularly limited, but is 500 Å or more and 1000 Å or less. When the thickness of the first layer 81 is within the above-described range, it is possible to curb a decrease in a light shielding property due to an increase in a distance between the first light shielding portion 6 and the second light shielding portion 210 while curbing a decrease in the light transmittance of the opening region A11 as compared with a case where the thickness falls outside the range.

As shown in FIGS. 23 and 24, the second layer 82 includes a first intermediate portion 821 and a second intermediate portion 822. The second intermediate portion 822 is disposed in the Y1 direction with respect to the first intermediate portion 821. The second layer 82 does not overlap a third light shielding portion 7 in plan view and is not coupled to the third light shielding portion 7. Specifically, the third light shielding portion 7 is disposed between the first intermediate portion 821 and the second intermediate portion 822 in plan view. In addition, the first intermediate portion 821 overlaps the first light shielding portion 6 in plan view. The second intermediate portion 822 may be omitted.

### 3. Modification Example

The embodiments illustrated above may be modified in various ways. Specific modifications that can be applied to the above-described embodiments are illustrated below. Two or more aspects arbitrarily selected from examples below may be combined appropriately as long as contradiction is not caused.

Each of the intermediate layers 8 and 8A may further include another layer.

In the above description, the third light shielding portion 7 is coupled to the second light shielding portion 210, but may not be coupled. In addition, the third light shielding portion 7 may be omitted.

In each of the embodiments described above, the electro-optical device 100 using an active matrix scheme is illustrated, but the present embodiment is not limited thereto and a drive scheme for the electro-optical device 100 may be, for example, a passive matrix scheme.

The driving scheme of the “electro-optical device” is not limited to a vertical electric field scheme, but may be a transverse electric field scheme. An example of the transverse electric field scheme may include an In Plane Switching (IPS) mode. Further, examples of the vertical electric field scheme may include a twisted nematic (TN) mode, a vertical alignment (VA) mode, a PVA mode, and an optically compensated bend (OCB) mode.

### 4. Electronic Apparatus

The electro-optical device 100 can be used in various electronic apparatuses.

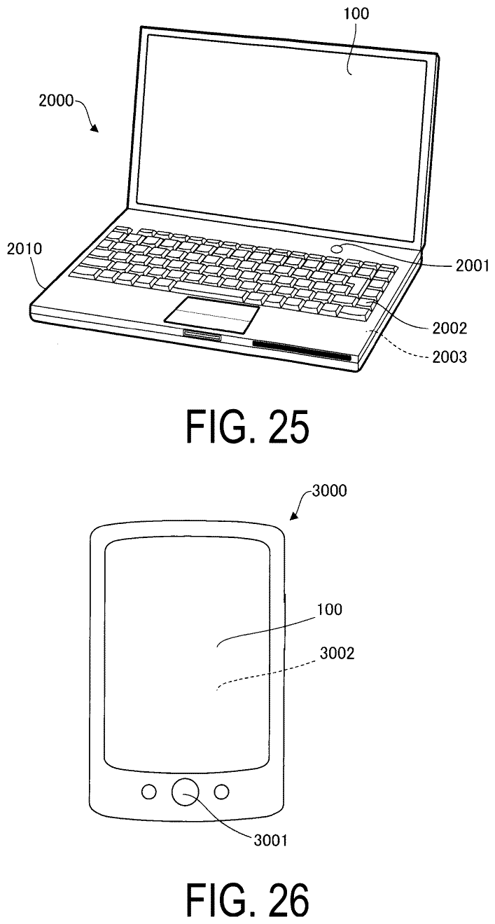

FIG. 25 is a perspective view showing a personal computer 2000 that is an example of the electronic apparatus. The personal computer 2000 includes the electro-optical device 100 that displays various images, a body unit 2010 in which a power switch 2001 and a keyboard 2002 are installed, and a control unit 2003. The control unit 2003 includes, for example, a processor and a memory, and controls an operation of the electro-optical device 100.

FIG. 26 is a plan view showing a smartphone 3000 that is an example of the electronic apparatus. The smartphone 3000 includes an operation button 3001, an electro-optical device 100 that displays various images, and a control unit 3002. Screen content displayed on the electro-optical device 100 is changed according to an operation of the operation button 3001. The control unit 3002 includes, for example, a processor and a memory, and controls an operation of the electro-optical device 100.

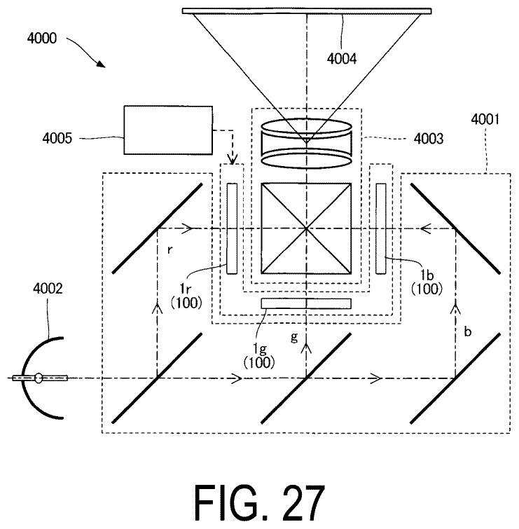

FIG. 27 is a schematic diagram showing a projector that is an example of the electronic apparatus. A projection type display apparatus 4000 is, for example, a three-panel projector. An electro-optical device 1r is an electro-optical device 100 corresponding to a red display color, an electro-optical device 1g is an electro-optical device 100 corresponding to a green display color, and an electro-optical device 1b is an electro-optical device 100 corresponding to a blue display color. That is, the projection type display apparatus 4000 includes three electro-optical devices 1r, 1g, and 1b corresponding to respective red, green, and blue display colors. A control unit 4005 includes, for example, a processor and a memory, and controls an operation of the electro-optical device 100.

An illumination optical system 4001 supplies a red component r of the light emitted from an illumination apparatus 4002, which is a light source, to the electro-optical device 1r, a green component g to the electro-optical device 1g, and a blue component b to the electro-optical device 1b. Each of the electro-optical devices 1r, 1g, and 1b functions as an optical modulator such as a light valve that modulates each monochromatic light beam supplied from the illumination optical system 4001 according to a displayed image. A projection optical system 4003 combines the light emitted from the respective electro-optical devices 1r, 1g, and 1b and projects the combined light onto a projection surface 4004.

The electronic apparatus includes the electro-optical device 100 described above and a control unit 2003, 3002, or 4005. The electro-optical device 100 described above has an excellent light shielding property because of the light shielding portion 6 of the semiconductor layer 231, and thus the destabilization of the operation of the transistor 23 is curbed. In this manner, the concern of the occurrence of display failures is curbed. Thus, with the electro-optical device 100, the display quality of the personal computer 2000, the smartphone 3000, or the projection type display apparatus 4000 can be increased.

An electronic apparatus to which the electro-optical device of the present disclosure is applied is not limited to the illustrated device, and examples thereof may include a personal digital assistant (PDA), a digital still camera, a television, a video camera, a car navigation apparatus, an in-vehicle display, an electronic notebook, an electronic paper, a calculator, a word processor, a workstation, a videophone, and a point of sale (POS) terminal. Further, examples of the electronic apparatus to which the present disclosure is applied may include a printer, a scanner, a copier, a video player, and a device including a touch panel.

Although the present disclosure has been described above based on the preferred embodiments, the present disclosure is not limited to the above-described embodiments. Further, a configuration of the respective portions of the present disclosure can be replaced with any configuration that performs the same function as that in the embodiment described above, or any configuration can be added.

Further, in the above description, the liquid crystal display device has been described as an example of the electro-optical device of the present disclosure, but the electro-optical device of the present disclosure is not limited thereto. For example, the electro-optical device of the present disclosure can be applied to an image sensor, or the like.

What is claimed is:

1. An electro-optical device comprising:
a substrate;
a transistor including a gate electrode disposed in a first direction with respect to the substrate and a semiconductor layer disposed between the substrate and the gate electrode;
a scanning line disposed in the first direction with respect to the gate electrode and electrically coupled to the gate electrode;
a first light shielding portion disposed in the first direction with respect to the semiconductor layer and overlapping the semiconductor layer in plan view when viewed in the first direction; and
a second light shielding portion disposed in a second direction opposite to the first direction with respect to the semiconductor layer and overlapping the semiconductor layer in plan view, wherein
a potential of the first light shielding portion and a potential of the second light shielding portion are different from each other,
the first light shielding portion includes a first portion that is provided on both sides of the semiconductor layer in a width direction and extends from a first insulating layer between the scanning line and the gate electrode to a second insulating layer between the semiconductor layer and the second light shielding portion,
an intermediate layer is disposed between the first portion and the second light shielding portion to be in contact with the first portion and the second light shielding portion, and
the intermediate layer includes a layer having an insulating property and contains a material different from materials of the first insulating layer and the second insulating layer.

2. The electro-optical device according to claim 1, wherein
the first light shielding portion further includes a second portion and a third portion,
the second portion is provided between the semiconductor layer and a layer in which the scanning line is provided,
the third portion is provided between the gate electrode and a layer in which the scanning line is provided, and
a length of the third portion in the second direction, a length of the second portion in the second direction, and a length of the first portion in the second direction are in ascending order, and the length of the first portion in the second direction is longest.

3. The electro-optical device according to claim 2, wherein a distance between the first portion and the semiconductor layer, a distance between the second portion and the semiconductor layer, and a distance between the third portion and the semiconductor layer are in ascending order, and the distance between the third portion and the semiconductor layer is the longest.

4. The electro-optical device according to claim 1, wherein
the semiconductor layer includes a drain region, a source region, and a channel region provided between the drain region and the source region,
the first light shielding portion is electrically coupled to the drain region and includes a portion overlapping the drain region in plan view, and
the second light shielding portion is electrically coupled to the gate electrode.

5. The electro-optical device according to claim 1, wherein the intermediate layer has a lower etching rate with respect to a fluorine-based etchant than those of the first insulating layer and the second insulating layer.

6. The electro-optical device according to claim 1, wherein the intermediate layer contains silicon nitride.

7. The electro-optical device according to claim 1, wherein the intermediate layer includes a first layer containing a metal and a second layer having an insulating property.

8. The electro-optical device according to claim 7, wherein the first layer includes the same material as that of the second insulating layer.

9. The electro-optical device according to claim 1, wherein the intermediate layer has a thickness larger than a thickness of the second light shielding portion.

10. An electronic apparatus comprising:
the electro-optical device according to claim 1; and
a control unit configured to control an operation of the electro-optical device.
